(19) United States
(12) Patent Application Publication
(10) Pub. No.: US 2025/0219914 A1
(43) Pub. Date: Jul. 3, 2025

(54) SYSTEM FOR MANAGING AND EVALUATING CLOUD SERVICE AND METHOD OF MANAGING AND EVALUATING CLOUD SERVICE USING THE SAME

(71) Applicant: OpsNow Inc., Seoul (KR)

(72) Inventor: Jae Young KIM, Seoul (KR)

(73) Assignee: OpsNow Inc., Seoul (KR)

(21) Appl. No.: 19/002,824

(22) Filed: Dec. 27, 2024

(30) Foreign Application Priority Data
Dec. 28, 2023 (KR) 10-2023-0195317

(51) Int. Cl. H04L 41/50; H04L 41/5009; H04L 67/10

(52) U.S. Cl. CPC H04L 41/5058; H04L 41/5009; H04L 67/10

(57) ABSTRACT

A system for managing and evaluating a cloud service includes a user terminal through which a user is provided with at least one cloud service, at least one cloud service provider (CSP) server configured to provide the user with the at least one cloud service through the user terminal, and a cloud service management server configured to communicate with the at least one CSP server and to compare at least one existing cloud service provided from the at least one CSP server to the user terminal and at least one candidate cloud service capable of being provided to the user terminal.

### BACKGROUND

### 1. Technical Field

The present disclosure relates to a system for managing and evaluating a cloud service and a method of managing and evaluating a cloud service using the same, and more particularly, to a system for managing and evaluating a cloud service, wherein a user compares and evaluates the existing cloud service and another cloud service (e.g., a cloud service of another cloud service provider) and an optimal cloud service is recommended for the user and a method of managing and evaluating a cloud service using the same.

### 2. Related Art

A public cloud refers to a cloud construction model in which a supplier (or provider) owns and operates computer resources and shares the computer resources with a plurality of tenants through the Internet. Today, cloud services are used in various business environments. Amazon Web Services (AWS), Microsoft Azure (Azure), etc. are served as representative global public clouds. Multiple companies tend to transfer IT assets within their companies from a local environment to a public cloud environment, and manage customer services and core workloads within their companies in public cloud environments.

In addition to the aforementioned representative public cloud services, a plurality of various public cloud services is present. Different performance and service costs may be provided to users depending on public cloud service providers (CSPs). In this case, the user who uses the cloud service wants a cheap service while being provided with performance having a desired level. That is, the user tends to select a cheap service for the same performance when purchasing and/or subscribing the cloud service.

For example, various cost reduction policies, such as a spot instance in which a preliminary capacity is used without a separate prior agreement, a savings plan in which a discounted fee is paid under the condition on which predetermined computing performance usage for a predetermined period is agreed, and a reserved instance in which an instance is reserved and used for a predetermined period, are provided by CSPs. In this case, in view of the characteristics of a conventional service environment in which only a comparison between different service types of the same CSP is limitedly possible, there is a problem in that a comparison and evaluation (in particular, a comparison and evaluation using a cost for the same performance) between cloud services that are provided by different CSPs (i.e., heterogeneous CSPs) are impossible.

The problems are described more specifically as follows. Today, each CSP may use a virtual machine (VM). Information on performance of the VM is provided to a user as the number of cores of a CPU and/or the number of threads. Illustratively, AWS having a high market share in the global market releases and provides two types of VM services including EC2 and Graviton service. However, AWS provides only information on the number of cores of a CPU and/or the number of threads with respect to different services of the same CSP, but has a problem in that accurate performance cannot be compared. In such a case, a performance difference may occur depending on accurate specifications of a CPU even between cloud services that disclose that they provide the same 1 core and 1 thread. For example, the VM service of AWS includes Graviton and EC2 and merely describes that Graviton has a cost reduction effect of about 20% (performance improved about 25%) for EC2, but does not provide accurate quantitative specifications of each service. In such a case, there is a problem in that a consumer has a difficulty in comparing and determining performance and costs according to quantitative numerical values.

Furthermore, various companies (i.e., CSPs) provide cloud services, but the CSPs adopt different costs and perform discount policies. For example, Google Cloud provides a cost discount to a user in proportion to a use period when the user who uses Google's cloud service uses the service for a predetermined period or more in the state in which a discount policy has not been applied. Accordingly, the user may be applied by the cost discount according to a use pattern of the cloud service of the user. In this case, there is a disadvantage in that it is difficult to apply a discount having maximum utility to the user because the type and unit of a discount policy provided by a CSP are different.

### PRIOR ART DOCUMENT

### Patent Document

(Patent Document 1) Korean Patent No. 10-2613081 (Dec. 11, 2023)

### SUMMARY

Various embodiments are directed to providing a system for managing and evaluating a cloud service, which maximize the utility of a user who uses a cloud service by expressing performance and a cost of each of a plurality of cloud services as a standardized numerical value, and a method of managing and evaluating a cloud service using the same.

Furthermore, a disclosed embodiment of the present disclosure provides a system for managing and evaluating a cloud service, which quantizes actual performance of a virtual machine (VM) of a cloud service provider (CSP) server for providing a plurality of cloud services by measuring the actual performance, calculates an actual discount cost according to the discount policy of each CSP, and recommends a cloud service (i.e., optimizes the cloud service) that is most suitable for a user, and a method of managing and evaluating a cloud service using the same.

Technical objects of the present disclosure are not limited to the aforementioned objects, and the other objects not described above may be evidently understood from the following description by those skilled in the art.

In an embodiment, a system for managing and evaluating a cloud service may include a user terminal through which a user is provided with at least one cloud service, at least one cloud service provider (CSP) server configured to provide the user with the at least one cloud service through the user terminal, and a cloud service management server configured to communicate with the at least one CSP server and to compare at least one existing cloud service provided from the at least one CSP server to the user terminal and at least one candidate cloud service capable of being provided to the user terminal.

Furthermore, the user terminal may provide the cloud service management server with use information of the at least one cloud service. The use information may include at least one of the name and unique information of the at least one cloud service.

Furthermore, the cloud service management server may include a benchmark module configured to measure performance of the at least one cloud service that is provided by the at least one CSP server connected to the cloud service management server for communication through an access module, a cost calculation module configured to obtain cost information of the at least one cloud service provided by the at least one CSP server, and a service optimization module configured to evaluate the at least one existing cloud service and the at least one candidate cloud service based on the performance of the at least one cloud service measured by the benchmark module and the cost information obtained by the cost calculation module.

Furthermore, the benchmark module may measure performance of each of the at least one existing cloud service and the at least one candidate cloud service. Required performance that belongs to the performance of the at least one existing cloud service may be measured based on usage obtained from the at least one CSP server that provides the at least one existing cloud service. Supply performance that belongs to the performance of the at least one existing cloud service may be measured based on CPU performance and memory performance obtained from the at least one CSP server that provides the at least one existing cloud service. Supply performance that belongs to the performance of the at least one candidate cloud service may be measured based on CPU performance and memory performance obtained from the at least one CSP server that provides the at least one candidate cloud service.

Furthermore, lower performance, among the CPU performance and the memory performance, may be determined to be the supply performance.

Furthermore, the at least one candidate cloud service may be determined based on at least one of the required performance of the existing cloud service and the supply performance of the existing cloud service.

Furthermore, the cost information obtained by the cost calculation module may include an on-demand cost and a discount rate

Furthermore, the discount rate may be calculated by incorporating at least one of a cloud service use pattern of the user, a desired use period, and a special discount policy related to the cloud service.

Furthermore, the service optimization module may compare the at least one existing cloud service and the at least one candidate cloud service by calculating correction performance conversion numerical values of the at least one existing cloud service and the at least one candidate cloud service. The correction performance conversion numerical value may include supply performance measured by the benchmark module for an estimated cost based on the cost information obtained by the cost calculation module.

Furthermore, the service optimization module may compare the correction performance conversion numerical value of the at least one existing cloud service and the correction performance conversion numerical value of the at least one candidate cloud service, and may recommend a cloud service having a relatively high correction performance conversion numerical value.

Furthermore, the service optimization module may compare cost information of the at least one existing cloud service and cost information of the at least one candidate cloud service when supply performance of the at least one candidate cloud service is higher than required performance that belongs to performance of the at least one existing cloud service, and may recommend a cloud service having relatively low cost information.

In an embodiment, a method of managing and evaluating a cloud service using a system for managing and evaluating a cloud service may include a benchmarking step of benchmarking, by a cloud service management server, performance of each of at least one existing cloud service and at least one candidate cloud service, a cost calculation step of obtaining, by the cloud service management server, cost information of each of the at least one existing cloud service and the at least one candidate cloud service, and a service optimization step of evaluating, by the cloud service management server, each of the at least one existing cloud service and the at least one candidate cloud service based on the performance and cost information of each of the at least one existing cloud service and the at least one candidate cloud service.

Furthermore, the benchmarking step may include a required performance acquisition step of obtaining required performance of a user by analyzing usage of the at least one existing cloud service, a supply performance acquisition step of measuring supply performance of at least one candidate cloud service different from the at least one existing cloud service, and a supply performance determination step of determining the supply performance based on the performance of the at least one candidate cloud service measured in the supply performance acquisition step.

Furthermore, the performance of the at least one candidate cloud service may be measured based CPU performance and memory performance obtained from at least one cloud service provider (CSP) server that provides at least one cloud service.

Furthermore, in the supply performance determination step, lower performance, among the CPU performance and the memory performance, may be determined to be the supply performance.

Furthermore, the cost calculation step may include at least one of a batch use discount application step of applying a batch use discount policy to a short-time use when a use pattern of a user for the at least one existing cloud service includes a batch type use instance, a long-term use discount application step of applying a long-term use discount policy corresponding to a desired use period when the desired use period received through a user terminal is a critical use period or more, and a special discount application step of applying a special discount policy when the special discount policy for each of the at least one existing cloud service and the at least one candidate cloud service is present.

Furthermore, the cost calculation step may further include a cost determination step of determining an estimated cost, based on cost information including a discount rate into which at least one of an on-demand cost of each of the at least one existing cloud service and the at least one candidate cloud service, a batch use discount policy, the long-term use discount policy, and the special discount policy has been incorporated.

Furthermore, the service optimization step may include comparing the at least one existing cloud service and the at least one candidate cloud service by calculating correction performance conversion numerical values of the at least one existing cloud service and the at least one candidate cloud service. The correction performance conversion numerical value may include supply performance relative to an estimated cost based on the cost information.

Furthermore, the service optimization step may include compares the correction performance conversion numerical value of the at least one existing cloud service and the correction performance conversion numerical value of the at least one candidate cloud service, and recommending a cloud service having a relatively high correction performance conversion numerical value.

Furthermore, the service optimization step may include comparing the cost information of the at least one existing cloud service and the cost information of the at least one candidate cloud service when supply performance of the at least one candidate cloud service is higher than required performance that belongs to the performance of the at least one existing cloud service, and recommending a cloud service having relatively low cost information.

According to the proposed embodiments, through the system for managing and evaluating a cloud service and the method of managing and evaluating a cloud service using the same according to the disclosed embodiments of the present disclosure, it is possible to compare performance and costs between different cloud services. In particular, if the existing cloud service provided by the existing CSP is transferred to a candidate cloud service provided by a different candidate CSP, it is possible to secure a rational basis for the transfer of the service. Such a basis may provide a user with accurate and measured information on performance and cost considerations when a user considers a transfer from the existing cloud service to another cloud service for various reasons, such as a cost, performance, and a service of the existing cloud service. Accordingly, there is an advantage in that a user who uses the existing cloud service can easily determine whether to transfer the existing cloud service to another cloud service.

Furthermore, through the system for managing and evaluating a cloud service and the method of managing and evaluating a cloud service using the same according to the disclosed embodiments of the present disclosure, various discount policies and/or cost optimization policies which may be provided from a CSP to a user may be considered. In particular, there are advantages in that a user can be provided with an optimal discount policy in which a cloud service use pattern of the user and a desired use period have been considered and can use a cloud service that is used in a business environment by maximizing the utilization of the cloud service.

### BRIEF DESCRIPTION OF THE DRAWINGS

FIG. 1 is for describing an exemplary structure of a system for managing and evaluating a cloud service according to a disclosed embodiment of the present disclosure.

FIG. 2 is an exemplary construction diagram of a cloud service management server of the system for managing and evaluating a cloud service according to a disclosed embodiment of the present disclosure.

FIG. 3 is for describing a relation between the cloud service management server and at least one CSP server in the system for managing and evaluating a cloud service according to a disclosed embodiment of the present disclosure.

FIG. 4 is an exemplary sequence diagram of a method of managing and evaluating a cloud service using the system for managing and evaluating a cloud service according to a disclosed embodiment of the present disclosure.

FIG. 5 is a detailed sequence diagram of a candidate cloud service determination step, that is, one step of the method of managing and evaluating a cloud service according to a disclosed embodiment of the present disclosure.

FIG. 6 is a detailed sequence diagram of a benchmarking step, that is, one step of the method of managing and evaluating a cloud service according to a disclosed embodiment of the present disclosure.

FIG. 7 is a detailed sequence diagram of a cost calculation step, that is, one step of the method of managing and evaluating a cloud service according to a disclosed embodiment of the present disclosure.

FIG. 8 is for describing a service optimization step, that is, one step of the method of managing and evaluating a cloud service according to a disclosed embodiment of the present disclosure.

### DETAILED DESCRIPTION

Advantages and characteristics of the present disclosure and a method for achieving the advantages and characteristics will become apparent from embodiments described in detail later in conjunction with the accompanying drawings. However, the present disclosure is not limited to the disclosed embodiments, but may be implemented in various different forms. The embodiments are merely provided to complete the present disclosure and to fully notify a person having ordinary knowledge in the art to which the present disclosure pertains of the category of the present disclosure. The present disclosure is merely defined by the category of the claims.

A first, a second, etc. are used to describe various components, but the components are not restricted by the terms. The terms are used to only distinguish one component from the other components. Accordingly, a first component that is described hereinafter may be a second component within the technical spirit of the present disclosure.

Throughout the specification, the same reference numeral denotes the same component.

Characteristics of several embodiments of the present disclosure may be partially or entirely coupled or combined and may be technically variously associated and driven as may be sufficiently understood by those skilled in the art. The embodiments may be independently implemented and may be implemented in an associative relation.

A potential effect that has not been specifically mentioned in the specification of the present disclosure and that may be expected by technical characteristics of the present disclosure is treated as if it has been described in this specification. The present embodiment has been provided to a person having ordinary knowledge in the art to more fully describe the present disclosure. Contents illustrated in the drawings may be exaggerated and represented compared to an implementation form of an actual invention. A detailed description of a component will be omitted or described in brief if it is deemed to make the subject matter of the present disclosure unnecessarily vague.

Hereinafter, embodiments of the present disclosure are described in detail with reference to the accompanying drawings.

In the following contents, a cloud service provider may be denoted as an abbreviation “CSP”.

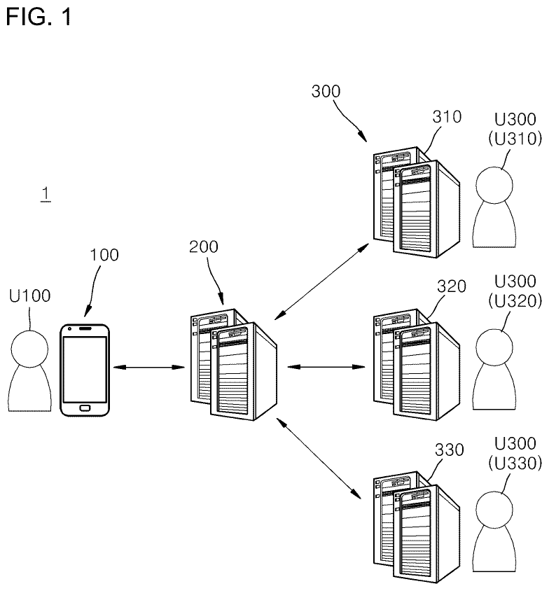

FIG. 1 is for describing an exemplary structure of a system 1 for managing and evaluating a cloud service according to a disclosed embodiment of the present disclosure.

Referring to FIG. 1, the system 1 for managing and evaluating a cloud service according to a disclosed embodiment of the present disclosure includes a user terminal 100, a cloud service management server 200, and at least one cloud service provider (CSP) server 300.

The system 1 for managing and evaluating a cloud service according to a disclosed embodiment of the present disclosure includes the user terminal 100. The user terminal 100 may be a component for enabling a user U100 to be provided with at least one cloud service. Furthermore, the user terminal 100 may be means for enabling the user U100 to use a method of managing and evaluating a cloud service using the system 1 for managing and evaluating a cloud service according to a disclosed embodiment of the present disclosure. Illustratively, the user terminal 100 may provide the user U100 with the method of managing and evaluating a cloud service according to a disclosed embodiment of the present disclosure through an application or a visual element, such as a web page. The user terminal 100 may include at least one of a portable terminal, a desktop PC, a laptop PC, and a tablet terminal, but is not essentially limited to the examples listed in this specification. The user terminal 100 may be at least one of the cloud service management server 200 and a device capable of wired or wireless communication. As illustrated in FIG. 1, the user terminal 100 has been illustrated in the form of a portable terminal, but the user terminal 100 may be a component having any form, which can communicate with the cloud service management server 200.

The system 1 for managing and evaluating a cloud service according to a disclosed embodiment of the present disclosure includes the cloud service management server 200. Illustratively, the cloud service management server 200 may constitute a kind of multi-cloud managing platform (MCMP). The cloud service management server 200 may communicate with the user terminal 100. The cloud service management server 200 may be provided with predetermined use information through the user terminal 100, may benchmark performance of a cloud service, and may calculate a comparison value having the same criterion by collecting cost information. Detailed contents of the cloud service management server 200 are described later.

The system 1 for managing and evaluating a cloud service according to a disclosed embodiment of the present disclosure includes the at least one CSP server 300. The at least one CSP server 300 may provide the user U100 with at least one cloud service through the user terminal 100. The at least one cloud service may be at least one of public cloud services, such as AZURE and AWS. Illustratively, the at least one CSP server 300 may include a first CSP server 310, a second CSP server 320, and a third CSP server 330. Among the first CSP server 310, the second CSP server 320, and the third CSP server 330, the first CSP server 310 may be a CSP server that provides the existing cloud service that is currently used by the user U100, and the second CSP server 320 and the third CSP server 330 may each be a CSP server that provides a candidate cloud service which may be subsequently used by the user U100.

The at least one CSP server 300 may be operated by a corresponding CSP U300. Illustratively, the first CSP server 310 may be operated by a first CSP U310. The second CSP server 320 may be operated by a second CSP U320. The third CSP server 330 may be operated by a third CSP U330. In the at least one CSP server 300, at least a part of a CSP server (e.g., the first CSP server) that provides the existing cloud service and at least a part of a CSP server (e.g., the second CSP server and/or the third CSP server) that provides a candidate cloud service to which the user U100 considers a transfer may be the same. That is, the first CSP server 310 may provide the existing cloud service and a first candidate cloud service. The second CSP server 320 may provide a second

The same CSP U300 may provide a plurality of cloud services having different performance and/or costs. The system 1 for managing and evaluating a cloud service according to a disclosed embodiment of the present disclosure may compare and evaluate different cloud services which may be provided by the same CSP based on the request of the user U100.

In the system 1 for managing and evaluating a cloud service according to a disclosed embodiment of the present disclosure, the user terminal 100 may provide the cloud service management server 200 with use information of at least one cloud service. In this case, the use information of the at least one cloud service that is provided by the cloud service management server 200 may be use information on the existing cloud service that is currently used by the user U100. Furthermore, the use information may include at least one of the name and unique information of the at least one cloud service. Illustratively, the use information may include at least one of the name of the at least one cloud service, the name of a CSP, the IP address of a CSP that provides at least one cloud service, and a unique identification code of a cloud service. The cloud service management server 200 may specify and access the first CSP server 310 based on the use information, and may obtain information (e.g., performance, cost information, usage, and a use pattern) for a comparison with a candidate cloud service through communication with the first CSP server 310.

Hereinafter, the cloud service management server 200, that is, one component of the system 1 for managing and evaluating a cloud service according to a disclosed embodiment of the present disclosure, is described more specifically.

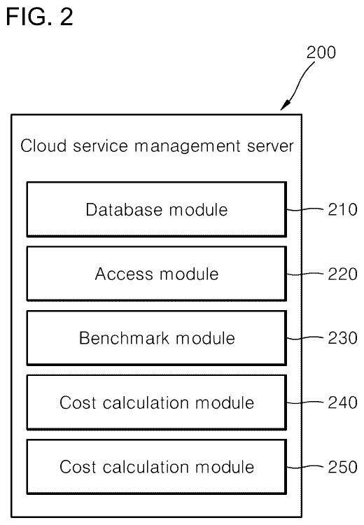

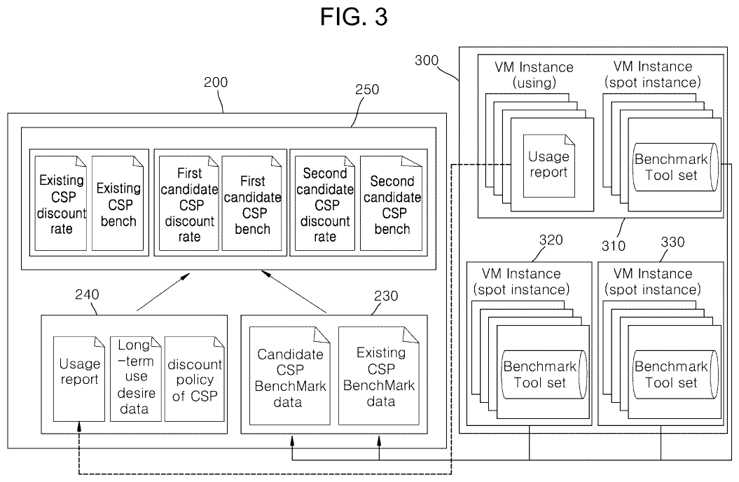

FIG. 2 is an exemplary construction diagram of the cloud service management server 200 of the system 1 for managing and evaluating a cloud service according to a disclosed embodiment of the present disclosure. FIG. 3 is for describing a relation between the cloud service management server 200 and the at least one CSP server 300 in the system 1 for managing and evaluating a cloud service according to a disclosed embodiment of the present disclosure.

Referring to FIGS. 1 to 3, the cloud service management server 200, that is, one component of the system 1 for managing and evaluating a cloud service according to a disclosed embodiment of the present disclosure, may communicate with the at least one CSP server 300.

Illustratively, the cloud service management server 200 may communicate with the first CSP server 310 that provides the user U100 with the existing cloud service through the user terminal 100, and may obtain usage that the user U100 uses the existing cloud service. Based on the obtained usage, required performance (or required computing power or demand computing power) that is required for the user U100 to use a cloud service may be measured. Furthermore, through communication between the cloud service management server 200 and the first CSP server 310, supply performance (or supply computing power) of the existing cloud service may be measured, and cost information of the existing cloud service may be obtained.

As another example, the cloud service management server 200 may communicate with the second CSP server 320 which may provide the user U100 with a candidate cloud service through the user terminal 100. Supply performance of a candidate cloud service may be measured. Cost information of a candidate cloud service may be obtained.

The cloud service management server 200 may compare at least one existing cloud service that is provided from the at least one CSP server 300 to the user terminal 100 and at least one candidate cloud service which may be provided to the user terminal 100. There are advantages in that the existing cloud service that is currently used by the user U100 and the usefulness of a candidate cloud service can be quantitatively compared by comparing at least one existing cloud service and at least one candidate cloud service and the user U100 who uses the existing cloud service can easily determine whether to transfer to another (candidate) cloud service.

Hereinafter, detailed components of the cloud service management server 200 are described.

The cloud service management server 200, that is, one component of the system 1 for managing and evaluating a cloud service according to a disclosed embodiment of the present disclosure, may include a database module 210. The database module 210 may store logic for communicating with the user terminal 100 and/or the at least one CSP server 300, logic for measuring performance of a cloud service (more accurately, the VM of performance of a cloud service) that is provided by the at least one CSP server 300, logic for calculating a correction performance conversion numerical value, and logic for performing a service optimization process. Furthermore, the database module 210 may store an application by which the method of managing and evaluating a cloud service according to a disclosed embodiment of the present disclosure is performed in the user terminal 100 through an access module 220.

Furthermore, the cloud service management server 200 may include the access module 220. The access module 220 may communicate with at least some of the user terminal 100 and the at least one CSP server 300. Illustratively, the access module 220 may transmit an application which enables the cloud service management server 200 to access the user terminal 100 and by which the method of managing and evaluating a cloud service according to a disclosed embodiment of the present disclosure is performed to the user terminal 100. As another example, the access module 220 may enable the cloud service management server 200 to access the at least one CSP server 300. The benchmark module 230 may measure performance of the at least one CSP server 300 accessed thereto (more specifically, performance of the VM of a corresponding CSP server).

Furthermore, the cloud service management server 200 may include a benchmark module 230. The benchmark module 230 may measure performance of at least one cloud service that is provided by the at least one CSP server 300 that is connected to the cloud service management server 200 for communication through the access module 220. Illustratively, the benchmark module 230 may measure performance of the existing CSP server (e.g., supply performance of the existing CSP server) that provides the existing cloud service that is currently used by the user U100. As another example, the benchmark module 230 may measure performance of a candidate CSP server (e.g., supply performance of a candidate CSP server) that provides a candidate cloud service which may be used by the user U100. In this case, performance of the CSP server is not absolute, and performance corresponding to a cloud service that is provided by each CSP server may be measured. The benchmark module 230 may measure CPU performance and memory performance of the VM of a cloud service that is provided by the at least one CSP server 300. Supply performance of the cloud service may be determined based on the measured CPU performance and memory performance. A detailed process of determining the supply performance of the cloud service is described later.

Furthermore, the cloud service management server 200 may include a cost calculation module 240. The cost calculation module 240 may obtain cost information of at least one cloud service that is provided through the at least one CSP server 300. Illustratively, the cost calculation module 240 may obtain cost information of the existing cloud service from the existing CSP server and cost information of candidate candidate cloud service from a CSP server. Additionally, the cost calculation module 240 may obtain information on a discount rate according to conditions, such as the use pattern and/or long-term use of the user U100.

Furthermore, the cloud service management server 200 may include a service optimization module 250. The service optimization module 250 may compare and evaluate at least one existing cloud service and at least one candidate cloud service, based on performance of at least one cloud service measured by the benchmark module 230 and cost information obtained by the cost calculation module 240. Illustratively, the “service optimization” of the service optimization module 250 may mean that a cloud service advantageous for the user U100 is recommended. The cloud service advantageous for the user U100 may refer to a cloud service having excellent performance for a cost (or price) and refer to a cheap cloud service.

Illustratively, the service optimization module 250 may compare performance of at least one existing cloud service and performance of at least one candidate cloud service. The service optimization module 250 may recommend a cloud service having better performance for the user U100 through the user terminal 100 by comparing performance of at least one existing cloud service and performance of at least one candidate cloud service.

As another example, the service optimization module 250 may compare a cost for at least one existing cloud service and a cost for at least one candidate cloud service. The service optimization module 250 may recommend a cloud service having a lower cost for the user U100 through the user terminal 100 by comparing a cost for at least one existing cloud service and a cost for at least one candidate cloud service.

As still another example, the service optimization module 250 may compare performance per unit price (e.g., a data throughput per unit price) of at least one existing cloud service and performance per unit price of at least one candidate cloud service. The service optimization module 250 may recommend a cloud service having greater performance per unit price for the user U100 through the user terminal 100 by comparing performance per unit price of at least one existing cloud service and performance per unit price of at least one

Hereinafter, an operational process of the system 1 for managing and evaluating a cloud service according to a disclosed embodiment of the present disclosure is described.

Referring to FIGS. 1 to 3 (in particular, FIG. 3), the benchmark module 230 of the cloud service management server 200, that is, one component of the system 1 for managing and evaluating a cloud service according to a disclosed embodiment of the present disclosure, may measure performance of each of at least one existing cloud service and at least one candidate cloud service. In this case, the benchmark module 230 may measure required performance and supply performance of the at least one existing cloud service, and may measure supply performance of at least one candidate cloud service. Illustratively, the required performance may be performance that is measured when the existing cloud service that is currently used by the user U100 is used. The supply performance may be performance that is measured through data processing simulations for the existing cloud service and/or a candidate cloud service.

Performance of a cloud service depends upon the computing speed of a CPU, the bandwidth of memory, and a storage capacity. Furthermore, if the CSP server 300 having excessively higher performance than required performance is used depending on the user U100, there is a concern that a cost to be paid by the user U100 will be excessively increased. Accordingly, the CSP server 300 that provides a cloud service having specifications proper for required performance may recommend the cloud service for the user U100.

Required performance that belongs to performance of at least one existing cloud service may be measured based on usage that is obtained from a CSP server that provides at least one existing cloud service. Illustratively, required performance of at least one existing cloud service may refer to a desired performance value when the user U100 uses a program included in a cloud service. The benchmark module 230 may measure VM instance usage that is recorded when the user U100 uses the existing cloud service. Required performance may be calculated based on the VM instance usage.

Illustratively, required performance of the existing cloud service may be calculated in the form of a data throughput per unit time (unit/s) based on usage that includes at least one of (e.g., monthly) CPU-maximum usage during a predetermined period unit that is provided through the existing CSP server, CPU-minimum usage during a predetermined period unit, and CPU-average usage during a predetermined period unit.

As another example, required performance of the existing cloud service may be supply performance that is obtained by benchmarking the existing cloud service. In this case, supply performance that belongs to performance of at least one existing cloud service may be measured based on CPU performance and memory performance that are obtained from at least one (existing) CSP server 300 that provides at least one existing cloud service.

As still another example, required performance of the existing cloud service may be obtained by blending a data throughput per unit time (unit/s) that is calculated based on usage provided through the existing CSP server and a data throughput per unit time (unit/s) that is measured based on CPU performance and memory performance obtained from the existing CSP server. For example, if required performance of the existing cloud service is measured on an arbitrary date, required performance from the beginning of a month including the arbitrary date to the arbitrary date may be calculated based on usage. Required performance from the arbitrary date to the end of the month may be calculated based on CPU performance and memory performance that are obtained by benchmarking the existing CSP server.

At least one candidate cloud service may be determined based on at least one of required performance of the existing cloud service and supply performance of the existing cloud service. Whether to consider a cloud service having higher performance, whether to consider a cloud service having lower performance, or whether to consider a cloud service having similar performance on the basis of the existing cloud service may be determined based on required performance of the existing cloud service obtained as described above. Illustratively, the user U100 may request a candidate cloud service having higher performance than the existing cloud service that is currently used to be recommended through the user terminal 100. As another example, the user U100 may request a candidate cloud service having lower performance than the existing cloud service that is currently used to be recommended through the user terminal 100. A candidate cloud service may be set to have higher supply performance than required performance and/or supply performance of the existing cloud service. A candidate cloud service may be set before required performance of the existing cloud service is obtained, if necessary, and may be subsequently selectively excluded from a service optimization process of the service optimization module 250.

Furthermore, supply performance that belongs to performance of at least one candidate cloud service may be measured based on CPU performance and memory performance that are obtained from at least one (candidate) CSP server 300 that provides at least one candidate cloud service. The supply performance may be obtained by measuring maximum performance which may be provided in the VM of the cloud service. That is, the supply performance may be measured by performing benchmark simulations on the VM of the cloud service.

In general, the CPU performance may be calculated by multiplying a clock speed, the number of instructions processed per clock cycle, and the number of core units. That is, the CPU performance may be calculated as “(CPU performance)=(a clock speed)*(instruction per cycle (IPC))*(the number of core units)”. However, the clock speed and the IPC cannot be accurately checked based on performance information that is provided by a CPU manufacturer.

Accordingly, the CPU performance may be calculated as a data throughput per time through the benchmark module 230. That is, the CPU performance may be calculated as “(CPU performance)=(the amount of data given−the amount of remaining data)/(a benchmark execution time)*(the number of core units)”, and may be calculated in the form of a data throughput per unit time (unit/s).

Furthermore, the memory performance may be calculated as the bandwidth of memory. That is, the memory performance may be calculated as “(memory performance)=(a bandwidth)=(the amount of data processed)/(a processing time or a benchmark execution time)”, and may be calculated in the form of a data throughput per unit time (unit/s).

Supply performance may be determined based on the CPU performance and the memory performance. The CPU performance and the memory performance that are measured by the benchmark module 230 may be quantitatively compared because the CPU performance and the memory performance have the same unit (a data throughput per unit time). In this case, a data throughput may be small when the bandwidth of the memory is small although the processing speed of a CPU is fast, and may be small when the processing speed of the CPU is slow although the bandwidth of the memory is great. Accordingly, for the realistic measurement of the supply performance, lower performance, among the CPU performance and the memory performance, may be determined to be the supply performance.

Contents that the CPU performance and the memory performance are obtained and contents that the supply performance is determined among the CPU performance and the memory performance may be identically applied to even a process of determining supply performance of the existing cloud service.

The cost calculation module 240 may obtain cost information of at least one existing cloud service and cost information of at least one candidate cloud service by communicating with the at least one CSP server 300 through the access module 220. In this case, the cost information obtained by the cost calculation module 240 may include an on-demand cost and a discount rate. The on-demand cost may refer to a cost that is imposed when a cloud service is used without a separate agreement. At least one CSP may provide various discount policies to the user U100 in order to reduce a burden of expenses of the user U100 and facilitate the use of its cloud service.

Illustratively, when a use pattern of the user U100 is a batch type use instance, non-real-time processing is performed for a specific one hour to two hours of 24 hours. A CSP may provide a discount corresponding to a batch type use instance. As another example, when a desired use period of the user U100 is a critical use period P or more, a long-term use discount may be applied to a cloud service which may be used by a corresponding user U100. As still another example, if the user U100 specifies that a specific capacity will be used for a specific period, a long-term use discount and/or a special discount may be applied to a cloud service which may be used by the user U100.

That is, the discount rate of cost information may be calculated by incorporating at least one of a cloud service use pattern of the user U100, a desired use period, and a special discount policy related to the cloud service.

As a result, the estimated cost of at least one existing cloud service and the estimated cost of at least one candidate cloud service may each be calculated as the product of an incorporation ratio of a discount rate into which both the on-demand cost of each cloud service and a corresponding discount policy have been incorporated. That is, the estimated cost of at least one existing cloud service and the estimated cost of at least one candidate cloud service may each be calculated as “(an estimated cost)=(an on-demand cost)*(1−a discount rate)”.

When the performance of the cloud service is measured by the benchmark module 230 and the cost information is obtained and the estimated cost is calculated by the cost calculation module 240 as described above, the service optimization module 250 may compare the at least one existing cloud service and the at least one candidate cloud service. Illustratively, the service optimization module 250 may compare the at least one existing cloud service and the at least one candidate cloud service by calculating a correction performance conversion numerical value. The correction performance conversion numerical value may be expressed as performance (unit/(s·won)) for the same unit amount and unit time. The correction performance conversion numerical value may be expressed as various units of a data throughput for a unit time (e.g., at least one of a month, a week, a day, a hour, a minute, and a second) and a unit cost (e.g., at least one of various currency units), if necessary.

More specifically, the correction performance conversion numerical value may include the supply performance measured by the benchmark module 230 for the estimated cost based on the cost information obtained by the cost calculation module 240. That is, the correction performance conversion numerical value may be defined as a data throughput per second when one won is paid on the basis of the estimated cost obtained by applying the discount rate to the on-demand cost. The correction performance conversion numerical value means performance of a cloud service for the same cost. Accordingly, a higher correction performance conversion numerical value may correspond to a cloud service having excellent performance for a cost. Accordingly, the service optimization module may compare the correction performance conversion numerical value of the at least one existing cloud service and the correction performance conversion numerical value of the at least one candidate cloud service, and may recommend a cloud service having a relatively high correction performance conversion numerical value for the user U100.

Accordingly, the user U100 of the system 1 for managing and evaluating a cloud service according to a disclosed embodiment of the present disclosure may compare and evaluate cloud services accurately and quantitatively based on a standardized numerical value (i.e., a correction performance conversion numerical value). Accordingly, there are advantages in that the user U100 can use a cloud service having maximum utility and can reduce a cost for constructing a business environment.

The service optimization module 250 may recommend a cloud service based on an index different from a correction performance conversion numerical value. Illustratively, when supply performance of at least one candidate cloud service is greater than required performance that belongs to performance of at least one existing cloud service, the service optimization module 250 may compare cost information of the at least one existing cloud service and cost information of the at least one candidate cloud service, and may recommend a cloud service having relatively low cost information. More specifically, if the supply performance of the at least one candidate cloud service has only to satisfy the required performance of the at least one existing cloud service, the superiority of subsequent supply performance may be excluded from an object for consideration. Instead, a cloud service having the smallest estimated cost, among one or more candidate cloud services that satisfy the required performance of the at least one existing cloud service, may be recommended for the user U100. Accordingly, there are advantages in that the user U100 can prevent an excessive cost increase and use a cloud service having a reasonable cost.

The service optimization module 250 may perform service optimization based on reference performance that is considered based on required performance of at least one existing cloud service, if necessary. Illustratively, the superiority of subsequent supply performance is not considered if supply performance of at least one candidate cloud service has only to satisfy the reference performance. A cloud service having the smallest estimated cost, among one or more candidate cloud services that satisfy the reference performance, may be recommended for the user U100. Accordingly, there are advantages in that the user U100 can prevent an excessive cost increase and use a cloud service having a reasonable cost.

Hereinafter, a method of managing and evaluating a cloud service using the system for managing and evaluating a cloud service according to a disclosed embodiment of the present disclosure is described. In describing the method of managing and evaluating a cloud service according to a disclosed embodiment of the present disclosure, the aforementioned contents are described in brief or a description thereof is omitted.

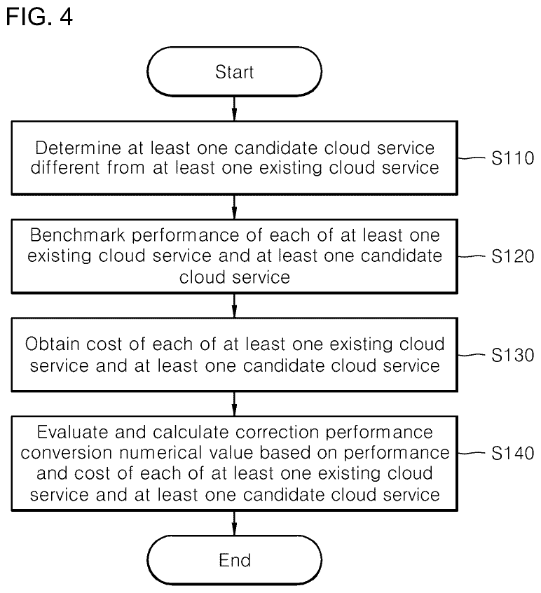

FIG. 4 is an exemplary sequence diagram of a method of managing and evaluating a cloud service using the system for managing and evaluating a cloud service according to a disclosed embodiment of the present disclosure.

Referring to FIG. 4, the method of managing and evaluating a cloud service using the system for managing and evaluating a cloud service according to a disclosed embodiment of the present disclosure includes a candidate cloud service determination step S110, a benchmarking step S120, a cost calculation step S130, and a service optimization step S140.

The candidate cloud service determination step S110 may be performed by at least one of the user terminal and the cloud service management server, and may be a step of determining at least one candidate cloud service that is different from at least one existing cloud service. In the candidate cloud service determination step S110, at least one of the user terminal and the cloud service management server may receive or select at least one candidate cloud service performance, a cost and a standardized index (e.g., a correction performance conversion numerical value) of which will be compared with those of at least one existing cloud service.

The benchmarking step S120 may be performed by the cloud service management server. The benchmark module, that is, one detailed component of the cloud service management server, may benchmark the performance of the at least one existing cloud service and the performance of the at least one candidate cloud service. Illustratively, in the benchmarking step S120, the cloud service management server may measure at least one of required performance and supply performance of the at least one existing cloud service. In this case, the required performance of the at least one existing cloud service may be calculated based on VM instance usage that is recorded on the existing CSP server that provides the at least one existing cloud service, and may be calculated in the form of a data throughput per unit time (unit/s) based on usage including at least one of CPU-maximum usage during a predetermined period unit, CPU-minimum usage during a predetermined period unit, and CPU-average usage during a predetermined period unit. The supply performance of the at least one existing cloud service may be measured based on CPU performance and memory performance that are obtained from a VM instance of the existing CSP server. In the same way, the supply performance of the at least one candidate cloud service may be measured based on CPU performance and memory performance that are obtained from a VM instance of a candidate CSP server.

The cost calculation step S130 may be performed by the cloud service management server. The cost calculation module, that is, one detailed component of the cloud service management server, may obtain cost information of the at least one existing cloud service and cost information of the at least one candidate cloud service. Illustratively, the cost information obtained in the cost calculation step S130 may include an on-demand cost and a discount rate. An estimated cost may be calculated based on the on-demand cost and the discount rate.

The service optimization step S140 may be performed by the cloud service management server. The service optimization module, that is, one detailed component of the cloud service management server, may evaluate the at least one existing cloud service and the at least one candidate cloud service, based on the performance and cost information of the at least one existing cloud service and the performance and cost information of the at least one candidate cloud service. Illustratively, in the service optimization step S140, standardized quantitative indices may be calculated based on the performance and cost information of the at least one existing cloud service and the at least one candidate cloud service, which are measured or obtained in the benchmarking step S120 and the cost calculation step S130. A cloud service having maximum utility may be recommended for a user based on a comparison between the standardized quantitative indices.

Hereinafter, the steps of the method of managing and evaluating a cloud service according to a disclosed embodiment of the present disclosure are described in detail.

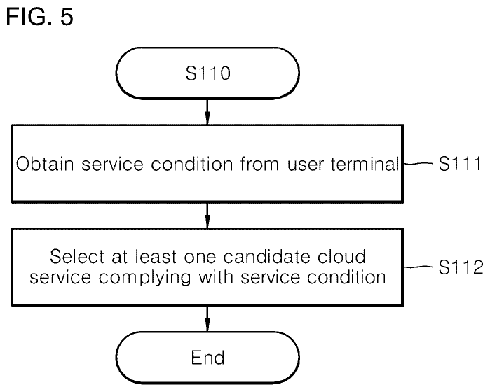

FIG. 5 is a detailed sequence diagram of the candidate cloud service determination step S110, that is, one step of the method of managing and evaluating a cloud service according to a disclosed embodiment of the present disclosure.

Referring to FIGS. 4 and 5, the candidate cloud service determination step S110, that is, one step of the method of managing and evaluating a cloud service according to a disclosed embodiment of the present disclosure, may include a service condition acquisition step S111 and a candidate cloud service selection step S112.

In the service condition acquisition step S111, a service condition may be obtained from the user terminal. The service condition may be obtained when a user inputs the service condition to the user terminal. Illustratively, the service condition may include at least one of reference performance (i.e., performance identical with required performance of the existing cloud service, performance higher than the required performance, or performance lower than the required performance), a desired use period, and desired usage of the user. The service condition may also include a CSP designated by the user, if necessary.

In the candidate cloud service selection step S112, at least one of the user terminal and the cloud service management server may select a candidate cloud service corresponding to the service condition. Illustratively, in the candidate cloud service selection step S112, disclosed performance (i.e., performance of a cloud service posted by a CSP so that supply performance can be estimated) higher than reference performance, the cloud service of a designated CSP, or a cloud service corresponding to desired usage may be selected.

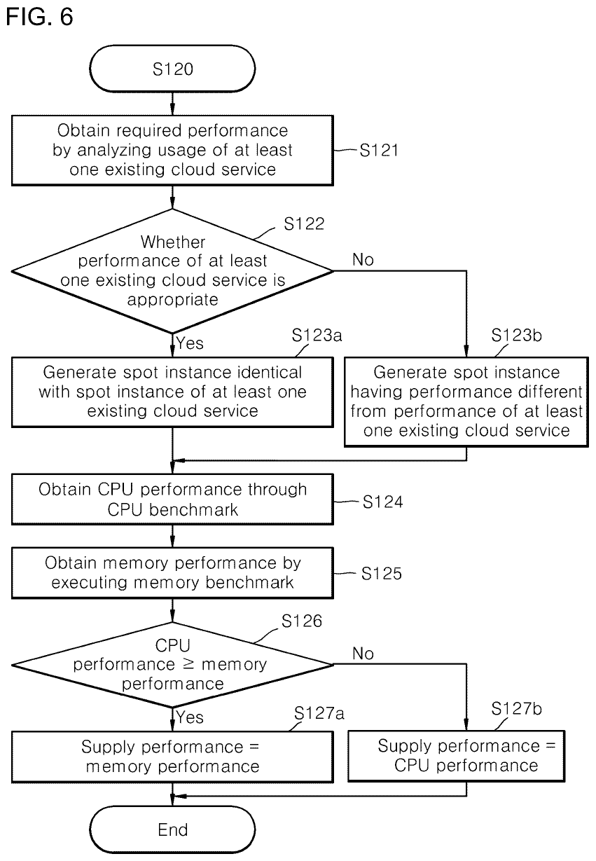

FIG. 6 is a detailed sequence diagram of the benchmarking step S120, that is, one step of the method of managing and evaluating a cloud service according to a disclosed embodiment of the present disclosure.

Referring to FIGS. 4 and 6, the benchmarking step S120, that is, one step of the method of managing and evaluating a cloud service according to a disclosed embodiment of the present disclosure, may include a plurality of steps. Illustratively, the benchmarking step S120 may include a required performance acquisition step S121. In the required performance acquisition step S121, the benchmark module, that is, one detailed component of the cloud service management server, may obtain required performance of a user by analyzing usage of the at least one existing cloud service. Illustratively, the required performance of the at least one existing cloud service may refer to a desired performance value when the user uses a program included in a cloud service. The benchmark module may measure VM instance usage that is recorded when the user uses the existing cloud service, and may calculate the required performance based on the VM instance usage. Illustratively, the required performance of the existing cloud service may be calculated in the form of a data throughput per unit time (unit/s) based on usage including at least one of (e.g., monthly) CPU-maximum usage during a predetermined period unit, which is provided through the existing CSP server, CPU-minimum usage during a predetermined period unit, and CPU-average usage during a predetermined period unit. As another example, the required performance of the existing cloud service may be supply performance that is obtained by benchmarking the existing cloud service. As still another example, the required performance of the existing cloud service may be obtained by blending a data throughput per unit time (unit/s) that is calculated based on usage provided by the existing CSP server and a data throughput per unit time (unit/s) that is measured based on CPU performance and memory performance obtained from the existing CSP server. Contents related to the required performance of the existing cloud service are the same as those of the system for managing and evaluating a cloud service according to a disclosed embodiment of the present disclosure and the same, and a description thereof is omitted.

Thereafter, a required performance determination step S122 may be performed. In the required performance determination step S122, whether the required performance of the at least one existing cloud service is appropriate may be determined. Illustratively, when the required performance of the at least one existing cloud service complies with an object (e.g., a service condition) of the user, a same spot instance generation step S123a of generating a spot instance identical with a spot instance of the at least one existing cloud service may be performed. As another example, when the required performance of the at least one existing cloud service does not comply with the object of the user, reference performance higher or lower than the required performance may be set, and a different spot instance generation step S123b of generating a spot instance having performance different from performance of the at least one existing cloud service so that the spot instance complies with the reference performance may be performed.

Thereafter, a supply performance acquisition step S124 and S125 may be performed. In the supply performance acquisition step S124 and S125, supply performance of at least one candidate cloud service that is different from at least one existing cloud service may be measured. Illustratively, the benchmark module, that is, one detailed component of the cloud service management server, may measure CPU performance and memory performance of the VM of the at least one candidate CSP server that provides at least one candidate cloud service. That is, the supply performance acquisition step S124 and S125 may include a CPU performance measurement step S124 and a memory performance measurement step S125.

In the CPU performance measurement step S124, the benchmark module, that is, one detailed component of the cloud service management server, may calculate “(CPU performance)=(the amount of data given−the amount of remaining data)/(a benchmark execution time)*(the number of core units)”. The CPU performance may be calculated in the form of a data throughput per unit time (unit/s). The CPU performance has been described above in detail.

In the memory measurement step S125, the benchmark module, that is, one detailed component of the cloud service management server, may calculate “(memory performance)=(a bandwidth)=(the amount of data processed)/(a processing time or a benchmark execution time)”. The memory performance may be calculated in the form of a data throughput per unit time (unit/s). The memory performance has been described above in detail.

The CPU performance measurement step S124 and the memory performance measurement step S125 have been illustrated as being sequentially performed, but are not essentially limited to the illustrated sequence. That is, the memory performance measurement step S125 may be first performed, and the CPU performance measurement step S124 may be then performed. The CPU performance measurement step S124 and the memory performance measurement step S125 may be simultaneously performed in parallel.

Thereafter, a supply performance comparison step S126 may be performed. In the supply performance comparison step S126, the benchmark module, that is, one detailed component of the cloud service management server, may compare the CPU performance and the memory performance having the same unit. The CPU performance and the memory performance may form a quantitative order relation.

Thereafter, a supply performance determination step S127a and S127b may be performed. In the supply performance determination step S127a and S127b, the benchmark module, that is, one detailed component of the cloud service management server, may determine supply performance based on performance (i.e., the CPU performance and the memory performance) of the at least one candidate cloud service, which are measured in the supply performance acquisition step S124 and S125. More specifically, a function of the at least one candidate cloud service may be measured based on the CPU performance and the memory performance that are obtained from the at least one CSP server that provides at least one cloud service. As in the aforementioned problem, a data throughput may be reduced if the bandwidth of memory is small although CPU performance is great, and may be reduced if CPU performance is small although the bandwidth of memory is great. Accordingly, for the realistic measurement of the supply performance, lower performance, among the CPU performance and the memory performance, may be determined to be the supply performance. That is, when the CPU performance is the memory performance or more, the supply performance may be determined (S127a) as the memory performance. When the CPU performance is less than the memory performance, the supply performance may be determined (S127b) as the CPU performance.

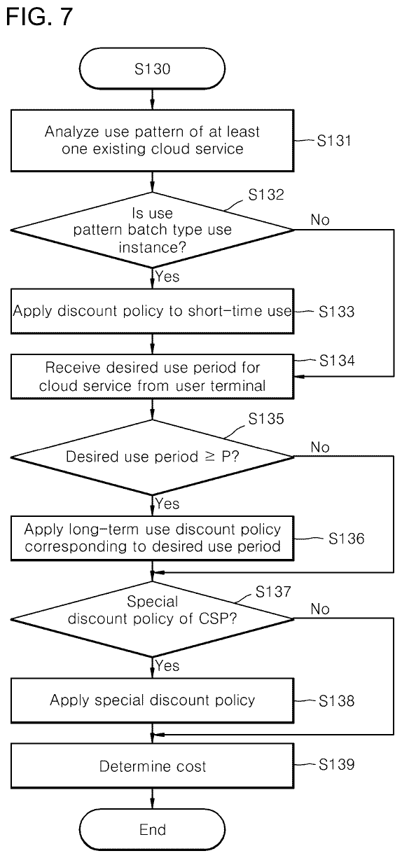

FIG. 7 is a detailed sequence diagram of the cost calculation step S130, that is, one step of the method of managing and evaluating a cloud service according to a disclosed embodiment of the present disclosure.

Referring to FIGS. 4 and 7, the cost calculation step S130, that is, one step of the method of managing and evaluating a cloud service according to a disclosed embodiment of the present disclosure, may include a plurality of steps. In the cost calculation step S130, the cost calculation module, that is, one detailed component of the cloud service management server, may provide a user with an estimated cost to which a maximum discount rate has been applied, by applying various discount policies.

The cost calculation step S130 include a use pattern analysis step S131. In the use pattern analysis step S131, the cloud service management server (e.g., at least one of the benchmark module and the cost calculation module) may obtain the use pattern of the user for the existing cloud service from the at least one existing CSP server and analyze the use pattern of the user.

After the use pattern analysis step S131, a use pattern determination step S132 may be performed. In the use pattern determination step S132, the cloud service management server (e.g., the cost calculation module) may determine whether the use pattern of the user for the existing cloud service is a batch type use instance that is concentrated on one hour to two hours of the day. Illustratively, when the existing cloud service use time of the user is two hours or less of the day, the cloud service management server the cloud service management server may determine the use pattern of the user to be a batch type use instance.

In the use pattern determination step S132, when the use pattern of the user is the batch type use instance, a batch use discount application step S133 may be performed. The batch use discount application step S133 may refer to a step of applying a discount rate which may be applied when at least one existing cloud service and at least one candidate cloud service are used in batch. More specifically, the batch use discount application step S133 may mean that a batch use discount policy for a short-time use is applied when the use pattern of the user for the at least one existing cloud service includes the batch type use instance. Accordingly, there are advantages in that a CSP can reduce resources and a user can use a cloud service at a discounted cost. Furthermore, the cost calculation step S130 may include

a desired use period input step S134. Illustratively, the cloud service management server may receive a desired use period from the user terminal. In the desired use period input step S134, information received in the service condition acquisition step S111 may be loaded, if necessary.

Thereafter, a long-term use determination step S135 may be performed. In the long-term use determination step S135, the cost calculation module of the cloud service management server may compare the desired use period received in the desired use period input step S134 and a critical use period P.

Thereafter, a long-term use discount application step S136 may be performed. In the long-term use discount application step S136, the cost calculation module of the cloud service management server may apply a long-term use discount policy corresponding to the desired use period when the desired use period received through the user terminal is the critical use period P or more. Accordingly, there are advantages in that a CSP can secure a long-term customer and a user can use a cloud service at a discounted cost.

Furthermore, the cost calculation step S130 may include a special discount policy determination step S137. Illustratively, the cost calculation module of the cloud service management server may determine whether a special discount policy of each of the at least one existing cloud service and the at least one candidate cloud service is applied. For example, if a new user-special discount is applied when an arbitrary candidate cloud service is newly used, a discount rate according to a special discount policy may be considered.

Thereafter, a special discount application step S138 may be performed. Illustratively, the cost calculation module of the cloud service management server may apply a special discount policy when the special discount policy of each of the at least one existing cloud service and the at least one candidate cloud service is present.

The cost calculation step S130 may include at least one of the batch use discount application step S133, the long-term use discount application step S136, and the special discount application step S138. Accordingly, a discount rate into which all of discount policies which may be applied to the user have been incorporated may be obtained.

Thereafter, the cost determination step S139 may be performed. Illustratively, the cost calculation module of the cloud service management server may determine an estimated cost based on the cost information of each of the at least one existing cloud service and the at least one candidate cloud service. More specifically, in the cost determination step S139, the cost calculation module may determine the estimated cost, based on the on-demand cost of each of the at least one existing cloud service and the at least one candidate cloud service and cost information including a discount rate into which at least one of a batch use discount policy, a long-term use discount policy, and a special discount policy has been incorporated. In this case, the estimated cost may be calculated “(estimated cost)=(an on-demand cost)*(1−a discount rate)”. There are advantages in that a user of the method of managing and evaluating a cloud service according to a disclosed embodiment of the present disclosure can be provided with a discount rate into which all of discount policies which may be applied to the user have been incorporated and a cost for a cloud service that is used in a business environment is reduced because an estimated cost is determined based on the discount rate into which all of the discount policies have been incorporated as described above.

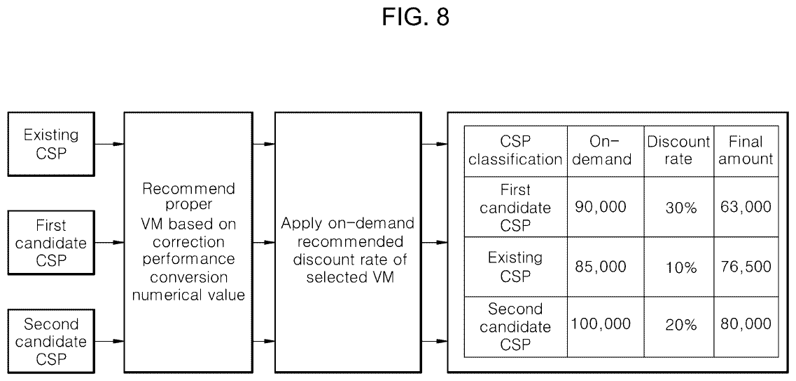

FIG. 8 is for describing the service optimization step S140, that is, one step of the method of managing and evaluating a cloud service according to a disclosed embodiment of the present disclosure.

Referring to FIGS. 4 and 8, in the service optimization step S140, the service optimization module, that is, one detailed component of the cloud service management server, may compare the at least one existing cloud service and the at least one candidate cloud service by calculating the correction performance conversion numerical values. Illustratively, the correction performance conversion numerical value may include supply performance measured by the benchmark module for an estimated cost based on cost information obtained by the cost calculation module, that is, one detailed component of the cloud service management server. That is, the correction performance conversion numerical value may be defined as a data throughput per second when one won is paid on the basis of an estimated cost obtained by applying a discount rate to an on-demand cost. The correction performance conversion numerical value means performance of a cloud service for the same cost. Accordingly, a higher correction performance conversion numerical value may correspond to a cloud service having excellent performance for a cost. Accordingly, in the service optimization step S140, the service optimization module may compare the correction performance conversion numerical value of the at least one existing cloud service and the correction performance conversion numerical value of the at least one candidate cloud service, and may recommend a cloud service having a relatively high correction performance conversion numerical value for a user.

Accordingly, the method of managing and evaluating a cloud service according to a disclosed embodiment of the present disclosure has advantages in that cloud services can be compared and evaluated accurately and quantitatively based on a standardized numerical value (i.e., a correction performance conversion numerical value) and a user can use a cloud service having maximum utility and reduce a cost for constructing a business environment.

Referring to contents illustrated in FIG. 8, it is assumed that the on-demand cost of a first candidate cloud service of a first candidate CSP is 90,000 won, the discount rate thereof is 30%, and the estimated cost thereof is 63,000 won and the on-demand cost of a second candidate cloud service of a second candidate CSP is 100,000 won, the discount rate thereof is 20%, and the estimated cost thereof is 80,000. In this case, when supply performance of the first candidate cloud service is 100,000 unit/min and supply performance of the second candidate cloud service is 60,000 unit/min, the correction performance conversion numerical value of the first candidate cloud service is “(100,000 unit/min)*(60 min/h)*(24 h/day)*(30 days/month)/(63,000 won)=68,571 unit/won·month”, and the correction performance conversion numerical value of the second candidate cloud service is “(60,000 unit/min)*(60 min/h)*(24 h/day)*(30 days/month)/(80,000 won)=32,400 unit/won month”. According to such calculation, the first candidate cloud service has a higher utility than the second candidate cloud service when the same cost is paid because the correction performance conversion numerical value of the first candidate cloud service is greater than the correction performance conversion numerical value of the second candidate cloud service. Accordingly, the service optimization module that performs the service optimization step S140 may recommend the first candidate cloud service for a user.

When required performance of the existing cloud service of the existing CSP is 80,000 unit/min, the correction performance conversion numerical value of the existing cloud service is “(80,000 unit/min)*(60 min/h)*(24 h/day)*(30 days/month)/(76,500 won)=45,176 unit/won·month”. According to such calculation, the first candidate cloud service has higher utility than the existing cloud service when the same cost is paid because the correction performance conversion numerical value of the first candidate cloud service is greater than the correction performance conversion numerical value of the existing cloud service. Accordingly, the service optimization module that performs the service optimization step S140 may recommend the first candidate cloud service for a user.

The service optimization module, that is, one detailed component of the cloud service management server that performs the service optimization step S140, may recommend a cloud service based on an index different from a correction performance conversion numerical value. Illustratively, in the service optimization step S140, when supply performance of the at least one candidate cloud service is higher than required performance that belongs to performance of the at least one existing cloud service, the service optimization module may compare cost information of the at least one existing cloud service and cost information of the at least one candidate cloud service, and may recommend a cloud service having relatively low cost information. More specifically, as long as the supply performance of the at least one candidate cloud service meets the performance requirements of the at least one existing cloud service, the superiority or inferiority of the subsequent supply performance can be excluded from consideration. Instead, a cloud service having the lowest estimated cost, among one or more candidate cloud services that satisfy the required performance of the at least one existing cloud service, may be recommended for a user. Accordingly, there are advantages in that a user can prevent an excessive cost increase and use a cloud service having a reasonable cost.

If necessary, in the service optimization step S140, the service optimization module may perform service optimization based on reference performance that is considered based on the required performance of the at least one existing cloud service. Illustratively, as long as the supply performance of the at least one candidate cloud service meets the reference performance, the superiority or inferiority of the subsequent supply performance is not considered, and a cloud service having the lowest estimated cost, among one or more candidate cloud services that satisfy the reference performance, may be recommended for a user. Accordingly, there are advantages in that a user can prevent an excessive cost increase and use a cloud service having a reasonable cost.

For example, if both the first candidate cloud service provided by the first candidate CSP server and the second candidate cloud service provided by the second candidate CSP server satisfy the required performance (or reference performance) of the existing cloud service, the service optimization module that performs the service optimization step S140 may recommend the first candidate cloud service for a user because the estimated cost for the first candidate cloud service is lower than the estimated cost for the second candidate cloud service.

According to the aforementioned contents, the system for managing and evaluating a cloud service and the method of managing and evaluating a cloud service using the same according to the disclosed embodiments of the present disclosure have advantages in that the user U100 can determine a cloud service having maximum utility based on a standardized index (i.e., a correction performance conversion numerical value or an estimated cost) and can maintain the existing cloud service that is currently used based on a corresponding the index or transfer to another candidate cloud service.

Furthermore, in the system for managing and evaluating a cloud service and the method of managing and evaluating a cloud service using the same according to the disclosed embodiments of the present disclosure, various discount policies and/or cost optimization policies which may be provided from a CSP to the user U100 can be considered. In particular, there are advantages in that the user U100 can provide an optimal discount policy by considering a cloud service use pattern and desired use period of the user U100 and the utilization of a cloud service that is used in a business environment can be maximized.

While the preferred embodiments of the present disclosure have been described above, the present disclosure is not limited to the embodiments, but may be modified and embodied in various ways within the technical scope of the present disclosure, which may also belong to the claims.

### DESCRIPTION OF REFERENCE NUMERALS

1: system for managing and evaluating cloud service
100: user terminal
200: cloud service management server
300: CSP server
S110: candidate cloud service determination step
S120: benchmarking step S130: cost calculation step
S140: service optimization step

What is claimed is:

1. A system for managing and evaluating a cloud service, the system comprising:
a user terminal through which a user is provided with at least one cloud service;
at least one cloud service provider (CSP) server configured to provide the user with the at least one cloud service through the user terminal; and
a cloud service management server configured to communicate with the at least one CSP server and to compare at least one existing cloud service provided from the at least one CSP server to the user terminal and at least one candidate cloud service capable of being provided to the user terminal.

2. The system of claim 1, wherein:
the user terminal provides the cloud service management server with use information of the at least one cloud service, and
the use information comprises at least one of a name and unique information of the at least one cloud service.

3. The system of claim 1, wherein the cloud service management server comprises:
a benchmark module configured to measure performance of the at least one cloud service that is provided by the at least one CSP server connected to the cloud service management server for communication through an access module;
a cost calculation module configured to obtain cost information of the at least one cloud service provided by the at least one CSP server; and
a service optimization module configured to evaluate the at least one existing cloud service and the at least one candidate cloud service based on the performance of the at least one cloud service measured by the benchmark module and the cost information obtained by the cost calculation module.

4. The system of claim 3, wherein:
the benchmark module measures performance of each of the at least one existing cloud service and the at least one candidate cloud service,
required performance that belongs to the performance of the at least one existing cloud service is measured based on usage obtained from the at least one CSP server that provides the at least one existing cloud service,
supply performance that belongs to the performance of the at least one existing cloud service is measured based on CPU performance and memory performance obtained from the at least one CSP server that provides the at least one existing cloud service, and
supply performance that belongs to the performance of the at least one candidate cloud service is measured based on CPU performance and memory performance obtained from the at least one CSP server that provides the at least one candidate cloud service.

5. The system of claim 4, wherein lower performance, among the CPU performance and the memory performance, is determined to be the supply performance.

6. The system of claim 4, wherein the at least one candidate cloud service is determined based on at least one of the required performance of the existing cloud service and the supply performance of the existing cloud service.

7. The system of claim 3, wherein the cost information obtained by the cost calculation module comprises an on-demand cost and a discount rate.

8. The system of claim 7, wherein the discount rate is calculated by incorporating at least one of a cloud service use pattern of the user, a desired use period, and a special discount policy related to the cloud service.

9. The system of claim 7, wherein:
the service optimization module compares the at least one existing cloud service and the at least one candidate cloud service by calculating correction performance conversion numerical values of the at least one existing cloud service and the at least one candidate cloud service, and
the correction performance conversion numerical value comprises supply performance measured by the benchmark module for an estimated cost based on the cost information obtained by the cost calculation module.

10. The system of claim 9, wherein the service optimization module
compares the correction performance conversion numerical value of the at least one existing cloud service and the correction performance conversion numerical value of the at least one candidate cloud service, and
recommends a cloud service having a relatively high correction performance conversion numerical value.

11. The system of claim 7, wherein the service optimization module
compares cost information of the at least one existing cloud service and cost information of the at least one candidate cloud service when supply performance of the at least one candidate cloud service is higher than required performance that belongs to performance of the at least one existing cloud service, and
recommends a cloud service having relatively low cost information.

12. A method of managing and evaluating a cloud service using a system for managing and evaluating a cloud service, the method comprising:
a benchmarking step of benchmarking, by a cloud service management server, performance of each of at least one existing cloud service and at least one candidate cloud service;
a cost calculation step of obtaining, by the cloud service management server, cost information of each of the at least one existing cloud service and the at least one candidate cloud service; and
a service optimization step of evaluating, by the cloud service management server, each of the at least one existing cloud service and the at least one candidate cloud service based on the performance and cost information of each of the at least one existing cloud service and the at least one candidate cloud service.

13. The method of claim 12, wherein the benchmarking step comprises:
a required performance acquisition step of obtaining required performance of a user by analyzing usage of the at least one existing cloud service;
a supply performance acquisition step of measuring supply performance of at least one candidate cloud service different from the at least one existing cloud service; and
a supply performance determination step of determining the supply performance based on the performance of the at least one candidate cloud service measured in the supply performance acquisition step.

14. The method of claim 13, wherein the performance of the at least one candidate cloud service is measured based on CPU performance and memory performance obtained from at least one cloud service provider (CSP) server that provides at least one cloud service.

15. The method of claim 14, wherein in the supply performance determination step, lower performance, among the CPU performance and the memory performance, is determined to be the supply performance.

16. The method of claim 12, wherein the cost calculation step comprises at least one of:
a batch use discount application step of applying a batch use discount policy to a short-time use when a use pattern of a user for the at least one existing cloud service comprises a batch type use instance;
a long-term use discount application step of applying a long-term use discount policy corresponding to a desired use period when the desired use period received through a user terminal is a critical use period or more; and
a special discount application step of applying a special discount policy when the special discount policy for each of the at least one existing cloud service and the at least one candidate cloud service is present.

17. The method of claim 16, wherein the cost calculation step further comprises a cost determination step of determining an estimated cost, based on cost information comprising a discount rate into which at least one of an on-demand cost of each of the at least one existing cloud service and the at least one candidate cloud service, a batch use discount policy, the long-term use discount policy, and the special discount policy has been incorporated.

18. The method of claim 12, wherein the service optimization step comprises:
comparing the at least one existing cloud service and the at least one candidate cloud service by calculating correction performance conversion numerical values of the at least one existing cloud service and the at least one candidate cloud service, and
the correction performance conversion numerical value comprises supply performance for an estimated cost based on the cost information.

19. The method of claim 18, wherein the service optimization step comprises:
compares the correction performance conversion numerical value of the at least one existing cloud service and the correction performance conversion numerical value of the at least one candidate cloud service, and
recommending a cloud service having a relatively high correction performance conversion numerical value.

20. The method of claim 12, wherein the service optimization step comprises:
comparing the cost information of the at least one existing cloud service and the cost information of the at least one candidate cloud service when supply performance of the at least one candidate cloud service is higher than required performance that belongs to the performance of the at least one existing cloud service, and
recommending a cloud service having relatively low cost information.
